(19) United States
(12) Patent Application Publication
(10) Pub. No.: US 2009/0074656 A1
(43) Pub. Date: Mar. 19, 2009

(54) Process for production of hydrogen from coal and other fossil fuels

(76) Inventor: Calvin Billings, Lake Charles, LA (US)

Correspondence Address: Douglas Baldwin, P.O. Box 485, Wellborn, TX, 77881, US

(21) Appl. No.: 12/283,862

(22) Filed: Sep. 16, 2008

Related U.S. Application Data
(60) Provisional application No. 60/994,182, filed on Sep. 18, 2007.

(51) Int. Cl. C01B 3/04

(52) U.S. Cl. 423/648.1

(57) ABSTRACT

A process for converting coal or other fossil fuel to hydrogen by reacting the fossil fuel or coal with water in a molten salt reactor at elevated temperatures in the presence of a magnesium silicate wherein the magnesium silicate reacts with the CO₂ produced in the reaction, thus removing it from the hydrogen gas product.

### CROSS REFERENCE TO RELATED APPLICATIONS

This application claims the benefit of U.S. Provisional Application, No. 60/994,182, filed Sep. 18, 2007.

### FIELD OF THE INVENTION

This invention relates to the production of hydrogen from coal and all other carbon containing fossil fuels. More specifically, this invention relates to a process for hydrogen production by the gasification of fossil fuels in a molten salt reactor followed by conversion of carbon monoxide to carbon dioxide and sequestration of the carbon dioxide with a magnesium silicate mineral.

### BACKGROUND

There is a growing demand for hydrogen for use as a clean fuel for many applications as well as for fuel in fuel cells. Coal and other fossil fuels are an abundant source of carbon that when reacted with oxygen and water produces hydrogen. Thus, gasification of coal is a logical source for the production of hydrogen. The purpose for doing so is to remove the carbon from the fuel so that it can be sequestered and not released to the atmosphere when burned. For example, there has been a recent breakthrough in producing natural gas from shale formations, adding substantially to reserves with a subsequent reduction in price. If it is continued to be used for fuel the carbon dioxide released will contribute to global warming. If the natural gas is converted to hydrogen by the method of this invention the carbon dioxide (CO₂) can be sequestered. Reference herein to coal gasification is to be understood to also refer to any fossil fuel where the carbon is converted to CO₂ and sequestered.

Gasifying coal is a 125 year old technology. If coal and steam are combined at about 1600° F. they react to form hydrogen and carbon monoxide (syngas). Depending on the coal type and the gasifier design, other products are present in the syngas, such as nitrogen, carbon dioxide, hydrogen sulfide, nitrogen oxides and mercury.

Carbon monoxide (CO) produced by gasification can be converted to carbon dioxide by the so called “water gas shift” reaction in which water and carbon monoxide are reacted to produce carbon dioxide and hydrogen. Many processes have been proposed for these purposes. However, a truly economical process is needed. The process must be simple in order to make it economical. If the syngas product is too expensive because the process and equipment are too elaborate then it will not be commercially viable.

The present invention provides such an economical process. It is designed to supply clean, pollution free, hydrogen fuel to industry.

### SUMMARY OF THE INVENTION

The process of this invention is a low cost, coal gasification/water gas shift process that captures and sequesters CO₂ in a rock mineral. The reactions are conducted in one reactor vessel having a tubular pre-reactor, from which the effluent products and reactants are further converted in a molten salt pool. The molten salt catalyzes the reactions and captures the undesirable contaminants so that further gas cleaning is not required. Carbon dioxide is optionally removed by sequestration with a magnesium silicate rock mineral, such as Olivine or Serpentine. In some instances there may be a use for the carbon dioxide or mixed flue gas for injection into oil formations for enhanced recovery. In this situation magnesium mineral will not be added to the bath to form magnesium carbonate. To capture sulfur compounds, calcium oxide or fly ash can be added to the bath to form calcium sulfide. The solid CaO is converted to CaSO₄ and withdrawn from the reactor system with the ash.

The salt bath is such an excellent catalytic and heat transfer medium that it is technically possible to achieve some degree of reaction without using a pre-reactor and simply pumping the reactants into the bath. However, the pre-reactor has proven much more effective, especially in providing reaction temperature to the bath.

In one embodiment, this invention is a process for producing hydrogen from a carbon containing fossil fuel comprising;

contacting carbon-containing fossil fuel, water and oxygen in a pre-reactor at an elevated temperature, to convert some of the carbon in the fossil fuel to hydrogen and carbon monoxide;

discharging effluent gas and solids from the pre-reactor below the surface of a molten salt pool under such conditions of residence time and temperature that carbon from the fossil fuel in the pre-reactor effluent is converted to hydrogen and carbon monoxide, and the carbon monoxide is converted to carbon dioxide, which, in turn, is reacted with magnesium silicate contained in the molten salt pool, and;

recovering hydrogen from the molten salt pool.

Excess water causes the CO to form CO₂ and H₂. Magnesium silicate, such as olivine, added to the salt bath reacts with the CO₂ to form MgCO₃. The only gas to leave the reactor is H₂ and N₂ (if air is the oxidant) and water vapor. All other compounds stay in the salt bath and are continuously drawn off in a purge cycle for recovery and recycle of the salt. In one embodiment where it is desirable to recover the carbon dioxide for other uses the magnesium silicate is eliminated and the produced gas will contain both hydrogen and carbon dioxide.

### DESCRIPTION OF THE DRAWINGS

FIG. 1 is a schematic diagram of the reactor and the process of the invention.

FIG. 2 is a schematic drawing of a gasification reactor of one embodiment of this invention.

### DESCRIPTION OF PREFERRED EMBODIMENTS

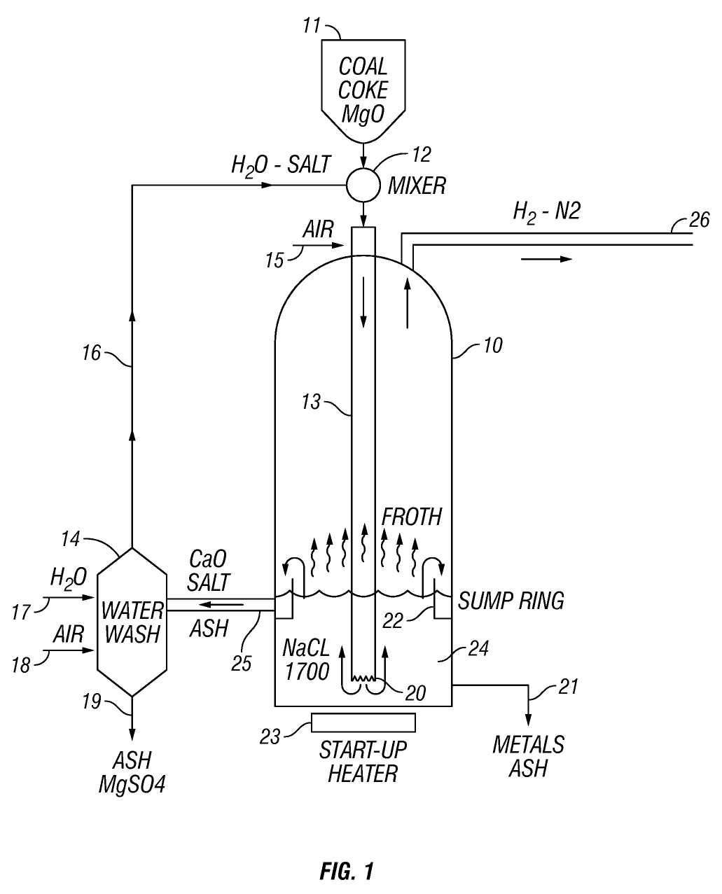

The process of the invention uses one reaction vessel, illustrated in FIG. 1. The reactor vessel comprises a vessel, 10, containing a pool of molten salt, 24, and a pre-reactor reaction tube, 13, extending from the inlet of the molten salt vessel into the pool of molten salt 24. Reactants are mixed in mixer 12 and fed into the pre-reactor tube, 13, where they are, at least, partially reacted. These partially reacted products are discharged, 20, into a pool of molten salt, 24, and the resulting reaction products are removed by way of outlet, 26.

Fossil fuel (coal, coke and various grades of petroleum or natural gas) and olivine are stored in a hopper 11 for feeding into the gasification reactor 10. These are mixed with water and recycle salt in mixer 12 and injected into pre-reactor 13 together with air (15) or oxygen. Reactor vessel 10 has an internal sump ring 22 for withdrawal of a salt/ash mixture from the reactor by way of a slip stream through conduit 25. This withdrawn mixture is washed in vessel 14 and the resulting washed salt is recycled to the reactor pre-reactor tube.

Startup heater 23 is provided to melt and preheat the salt at startup. Hydrogen product exits the reactor 10 by conduit 26. The reactor vessel is also provided with a means, 21, to draw off salt and contaminants at the bottom of the reactor vessel.

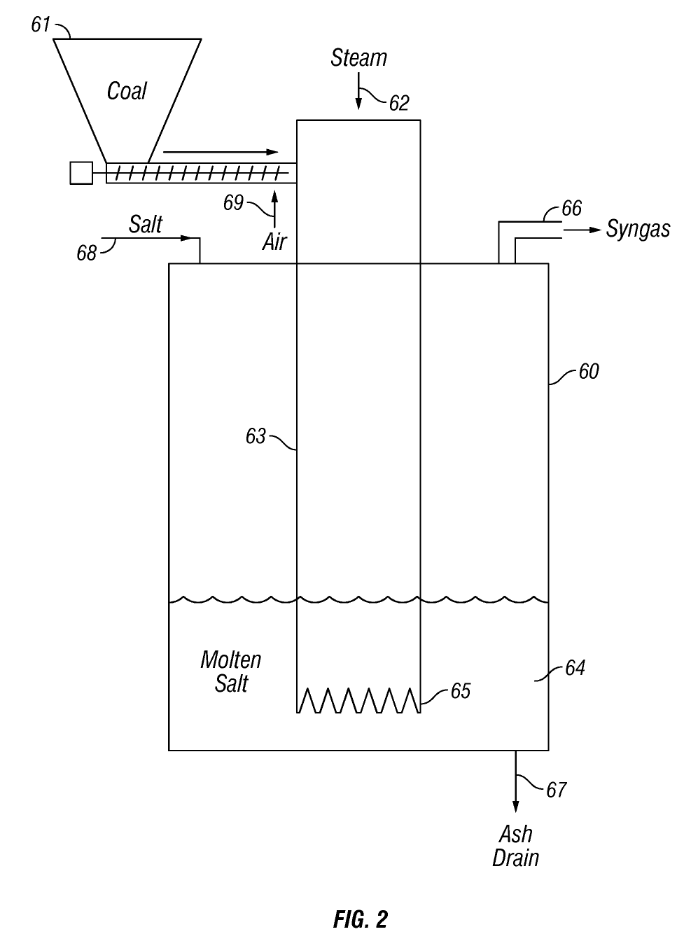

FIG. 2 shows some important features of the reactor system in more detail. The reactor vessel (60) is the reactor vessel corresponding to vessel 10 in FIG. 1, having molten salt (64) and a pre-reactor tube 63. Coal and magnesium silicate from hopper 61 are mixed with oxygen (or air) (69) and fed into the pre-reactor. Make-up salt in added at 68. The product hydrogen (and nitrogen, if air is used) is withdrawn at 66 and ash and metals are withdrawn at 67. A key feature of the pre-reactor tube, in one embodiment, is a series of V notches (65) cut around the circumference of the bottom outlet as illustrated in FIG. 2. These notches allow the gas to emerge out in a continuous small stream. Without them the gas tends to emerge in surges that form large bubbles and prevent good intermix of the gas and salt. Other means of dispersing the effluent gas such as a screen, holes around the circumference, etc may also be used effectively, however the notches have performed well.

The reactor may operate from atmospheric pressure to about 150 atmospheres. The construction and materials for the reactor vessel and other components of the system are selected to accommodate the operating temperatures and pressure.

It has been determined that an effective ratio of feed to salt is between 1 part feed per hour to 10-100 parts salt, and more preferably about 1-15. The preferred feed to water ratio is 1 part feed to 1-5 parts water, and more particularly 1-2. The preferred percentage of magnesium silicate in the reactor is between 5-20 percent of the salt content, and more preferably about 8 percent.

### The Process

Referring to the reactor system in FIG. 1, the salt first has to be brought up to operating temperature (1500 F to 2000 F) using external heater 23. Once the salt is melted the hot effluent from the pre-reactor (13) sustains the salt temperature. Powdered coal/coke or a mixture thereof is stored in bin 11 (FIG. 1). Additionally, about 8% olivine is mixed in with the coal to capture sulfur and CO₂ released in the reaction. Water is fed with the coal mix into a mixer 12 to create a slurry that is sprayed into the pre-reactor tube 13. Air or oxygen is fed in separately by conduit 15 into the top of pre-reactor tube 13. The coal is ignited and about 20% (in one embodiment) is burned to provide heat for the reaction, C+H₂O→H₂+CO. This reaction occurs in the pre-reactor tube. The temperature will be from about 1500 F to 2000 F, with 1700 F to 1800 F being preferred. The gas travels down the pre-reactor tube and emerges below the surface of the molten salt bath (20) where any un-reacted carbon is converted. Sulfur in the coal is converted to hydrogen sulfide in the pre-reactor tube and further reacts in the molten salt bath to form a metal sulfide. Mercury is also absorbed by the salt bath and ammonia and nitrous oxides are reduced to their basic elements. Ash is physically washed out of the gas stream and accumulates in the bath. Chlorine is retained as a metal chloride. As these various compounds accumulate in the bath they have to be purged in continuous bleed slip streams 25 and 21 and fresh salt such as sodium chloride is added to keep the salt active and fluid (preferable by recycle of salt washed from the ash/salt bleed stream 16). Ash in the coal is physically washed out of the gas by the liquid salt. As the gas flows through and out of the salt it forms a froth on the surface that is an excellent contact medium to clean the gas of all particulates, sulfur, mercury and nitrogen compounds. Inside the reaction vessel is a sump ring 22 that collects excess salt and ash as it builds up. The froth action spills over into the sump ring and the salt and ash are drained off, 25, into water wash unit 14. Here the mixture is washed with water to remove the salt from the solids. The salt is recycled and the solids discarded. Salt water from the washing is recycled (16) back to the top to make a slurry with the coal feed.

There is provided a drain from the bottom of reaction vessel (21) to remove metals that are too heavy to come out with the ash.

If it is undesirable to have nitrogen in the product hydrogen gas, the gasification in the reaction vessel may be carried without oxygen. In this embodiment of the invention, carbon (from) coal will react with steam (water) to form syngas. When oxygen is used, the required heat is generated by the reaction of oxygen and coal. When oxygen is not used heat must be supplied. This may be accomplished by indirect heating of the pre-reactor tube, as by providing an annular space around the tube and firing it with fuel and oxygen—the product hydrogen may be used as fuel, if desired.

As CO begins to form from the gasification reaction (C+H₂O→CO+H₂) the addition of extra water forms CO₂ (C+2H₂O→CO₂+2H₂) and additional H₂, the water gas shift reaction (WGS). When the CO₂ contacts magnesium silicate in the salt pool it is converted to MgCO₃, effectively removing CO₂ from the gas stream, enabling the WGS reaction to proceed faster. Gas leaving the top of the reactor is H₂, (and N₂ if air is used) and water vapor.

In the reaction vessel the molten salt level will be about 15 to 45 percent of the total height of the vessel with about ⅓ the height being especially preferred.

Many salts can be used in the (syngas) reaction vessel, but the most economical is sodium chloride. Its availability is virtually unlimited and its disposal is benign. Other salts that are suitable include metal chlorides, carbonates, sulfates, sulfites, nitrates, nitrites, bromides, oxides, hydroxides, per chlorates and mixtures thereof. These will work equally well or better than sodium chloride. However, there is a billion tons of coal burned annually in the US and the pollutants are in the hundreds of millions of tons. These pollutants have to be purged from the system to keep the salt active and fluid. A constant bleed of the salt bath and a constant re-supply of salt must occur. A percentage of the purge stream will be sodium chloride (or other salt used in the molten salt bath). It can be recovered by water wash and recycling the water or it can be disposed of. The point is, due to the huge volume of salt involved it desirable that it be the most abundant and cheapest available, that is, sodium chloride.

Several magnesium silicate minerals are suitable for use in reacting with the CO₂, including serpentine [Mg₃(Si₂O₅)(OH)₄], enstatite (MgSiO₃), and olivine, which actually represents a mineral group encompassing the solid-solution series between magnesium-rich (forsterite, Mg₂SiO₄) and iron-rich (fayalite, Fe₂SiO₄). Wollastonite 9CaSiO₂) is also suitable. To some extent fly-ash can also be used but is less effective. The process is capable of gasification of all grades of coal, petroleum coke, petroleum and natural gas, with capture and disposal of inherent pollutants, including CO₂. Only hydrogen and nitrogen are produced in one embodiment of the invention.

During the in-reactor removal of CO₂, there is produced a residue of reacted magnesium silicate product and other solids. This residue and ash can be used as landfill, and possibly for road and building material.

Waste water is recycled through the system and/or used for boiler water makeup, etc.

### EXAMPLE

The following test illustrates the efficacy of the gasifier reactor to achieve a high degree of gasification of powdered high sulfur coal.

### Test Results

A prototype reaction vessel consisting of a 11″×29″ inconel vessel fitted with a 6.5″×36″ stainless steel pre-gasifier tube that is notched on the bottom and extends to 2″ off the bottom of the vessel was used for these tests. The vessel was filled with 40 pounds of NaCl salt and 2 pounds of olivine. It was heated by external electric heaters to 1750° F. and created a depth of 10 inches molten bath. A coal slurry ground to an average of 50 microns was mixed with two parts water to make a pumpable slurry. The slurry was pumped into the reactor at a flow rate of 3 ounces per minute. After ten minutes a sample of the outlet gas was collected and sent to a commercial lab for analysis. They reported:

### H₂—99.8%

### CO—0%,

### CO₂—0%

### Sulfur—0%.

Several repetitive tests were run with duplicate results.

Another test was run with no olivine in the salt bath and the results were:

### H₂—77%

### CO₂—17%.

This shows that CO₂ would be available for enhanced oil recovery or other purposes if desired.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. A process for producing hydrogen from a carbon containing fossil fuel comprising;
contacting fossil fuel, water and oxygen in a pre-reactor at an elevated temperature, to convert some of the carbon in the fossil fuel to hydrogen and carbon monoxide;
discharging effluent gas and solids from the pre-reactor below the surface of a molten salt pool under such conditions of residence time and temperature that carbon from the fossil fuel in the pre-reactor effluent is converted to hydrogen and carbon monoxide, and the carbon monoxide is converted to carbon dioxide, which, in turn, is reacted with magnesium silicate contained in the molten salt pool, and;
recovering hydrogen from the molten salt pool.

2. The process of claim 1 wherein the fossil fuel is coal.

3. The process of claim 2 wherein sulfur and nitrogen compounds present in the coal are retained in the molten salt.

4. The process of claim 1 wherein the molten salt pool are selected from a group consisting of metal chlorides, carbonates, sulfates, sulfites, nitrates, nitrites, bromides, oxides, hydroxides, perchlorates, and mixtures thereof.

5. The process of claim 4 wherein the molten salt pool comprises sodium chloride.

6. The process of claim 1 wherein the salt pool is maintained at a temperature between about 1500 F. and about 2000 F.

7. The process of claim 1 wherein the magnesium silicate is selected from a group of minerals comprising serpentine, enstatite, wollastonite, foresterite and olivine.

8. The process of claim 5 wherein the magnesium silicate is olivine.

9. The process of claim 1 wherein the source of magnesium silicate enters the pre-reactor with the fossil fuel and converted magnesium silicate and other contents of the magnesium silicate source are drawn off the molten salt pool in a slip-stream.

10. The process of claim 1 wherein calcium oxide or fly ash is added to the salt bath to convert sulfur compounds to solids for easy removal from the salt.

11. The process of claim 1 wherein the pre-reactor is a tube that terminates below the surface of the molten salt pool and wherein the bottom of the pre-reactor tube has a series of V shaped cuts around the circumference.

12. A process for producing hydrogen from coal comprising;
contacting powered coal, water and oxygen in a pre-reactor at a temperature of from between 1500 F and 2000 F, to convert some of the carbon in the coal to hydrogen and carbon monoxide;
discharging effluent gas and solids from the pre-reactor below the surface of a molten salt pool comprising sodium chloride under such conditions of residence time and temperature that carbon from the fossil fuel in the pre-reactor effluent is converted to hydrogen and carbon monoxide, and the carbon monoxide is converted to carbon dioxide, which, in turn, is reacted with magnesium silicate in an olivine mineral contained in the molten salt pool, and;
recovering hydrogen from the molten salt pool.

13. A process for producing hydrogen from a carbon containing fossil fuel comprising;
contacting fossil fuel, water and oxygen in a pre-reactor at an elevated temperature, to convert some of the carbon in the fossil fuel to hydrogen and carbon monoxide;
discharging effluent gas and solids from the pre-reactor below the surface of a molten salt pool under such conditions of residence time and temperature that carbon from the fossil fuel in the pre-reactor effluent is converted to hydrogen and carbon monoxide, and the carbon monoxide is converted to carbon dioxide, and;
recovering hydrogen and carbon dioxide from the molten salt pool.

14. The process of claim 13 wherein the fossil fuel is coal, the salt pool is maintained at a temperature of between 1500 F and 2000 F, and the molten salt comprises sodium chloride.
